(19) United States
(12) Patent Application Publication
(10) Pub. No.: US 2010/0151078 A1
(43) Pub. Date: Jun. 17, 2010

(54) PASTA WITH A REDUCED AMOUNT OF DIGESTIBLE STARCH

(75) Inventor: Werner Seiler, Zuberwangen (CH)

Correspondence Address: HESLIN ROTHENBERG FARLEY & MESITI PC, 5 COLUMBIA CIRCLE, ALBANY, NY, 12203, US

(73) Assignee: Buhler AG, Uzwil (CH)

(21) Appl. No.: 11/719,935

(22) PCT Filed: Sep. 7, 2005
(86) PCT No.: PCT/CH2005/000533

§ 371 Date: May 29, 2009

(30) Foreign Application Priority Data
Nov. 22, 2004 (DE) 10 2004 056 337.3

(51) Int. Cl. A23L 1/16; A23L 1/105

(52) U.S. Cl. 426/28; 426/64

(57) ABSTRACT

The invention concerns a method for producing pasta in which the amount of starch that can be digested in the gastrointestinal tract is less than 50%, said method involving the following steps: a) introducing a dry, raw material mixture, which contains starch and protein and comprises flour and/or semolina, together with water, steam and at least one active ingredient into a closed, forced-conveyance reactor, in which mixing produces a moistened raw material mixture which is then subjected to alternating stress by kneading and working under the effects of temperature and pressure during a predetermined dwelling time in the reactor, in order to partly convert the starch into a broken-down or swellable state and together with the protein and the active ingredient to form a matrix that penetrates the pasta thus obtained; b) shaping of the pasta thus obtained into defined pasta shapes; and c) drying of the shaped pasta shapes to produce a pasta product.

The invention relates to a method and a device for manufacturing pasta products, less than 50% of the starch in which is digestible in the gastrointestinal tract. In addition, the invention relates to the pasta products manufactured in this way, and to a raw material dry mixture for manufacturing these pasta products.

Pasta products are regarded as healthy foods, since they are manufactured out of healthy raw materials. As a hedge against the increasingly encountered diseases in conjunction with our modern civilization, such as sugar diabetes (diabetes), cardiopulmonary diseases (arteriosclerosis) or tumors, in particular in the large intestine, it is proposed that we introduce various changes in our eating habits and/or changes in our basic food staples. On the one hand, it is suggested that we eat more slowly, and as a consequence, less given the feeling of being full that is reached before finishing. A diet less rich in carbohydrates is also suggested.

In an effort to satisfy this need, the percentage of easily digestible carbohydrates was reduced in numerous foodstuffs by adding proteins, nutritional fibers, etc. Soya, sweet lupins or the like can be used for these purposes.

In addition, film binders (hydrocolloids), e.g., xanthan, galactomannan, inulin, etc., were mixed in during the manufacture of starch-containing foods, like pastas or breads. This makes it possible to impede, and hence slow, the enzymatic action on the starch molecules required for starch digestion.

This yields a slow and steady resorption of the glucose that result from the enzymatic breakdown of starch, thereby preventing excessive fluctuations in the blood sugar level (low-glycemic effect), and simultaneously evoking a longer-lasting feeling of fullness in the consumer.

Therefore, a portion of the starch contained in these foods enters the large intestine undigested, providing nutrients to the intestinal bacteria there (prebiotic effect).

In addition, this measure makes it possible to influence the textural properties of the foods (organoleptic effect).

However, these three aspects—low-glycemic, prebiotic and organoleptic effects—cannot be optimally realized using these or similar measures alone. This is already hard enough in baked goods, but even more difficult for pastas, since their cooking properties are also to be optimal.

Therefore, the object of the invention is to provide a method and a device that make it possible, proceeding from raw materials with or without gluten protein, to manufacture high quality pastas, which have an as low-glycemic and particularly pronounced prebiotic effect as possible on the one hand, and have optimal cooking properties and responsive organoleptic properties on the other.

This object is achieved with respect to the method by manufacturing pastas containing less than 50% starch that can be digested in the gastrointestinal tract as follows:

A raw material dry mixture containing flour and/or semolina and protein along with water, vapor and at least one active substance are supplied to a closed, force-conveying reactor, in which mixing produces a moistened raw material mixture, which is alternately subjected to kneading and working while exposed to a predetermined temperature and pressure during a predetermined retention time in the reactor. This partially converts the starch into a solubilized or swellable state, thereby working together with the protein and active substance to form a matrix permeating the dough obtained in this way. Whether the proteins contain gluten or water-soluble proteins or not here plays a secondary role.

The dough obtained in this way is then molded into defined dough structures, and the molded dough structures are dried into pasta products.

The interplay between water, vapor, active substance and starch during alternating exposure to kneading and working under defined temperature, pressure and retention time conditions makes it possible to manufacture gluten-containing or gluten-free pasta products with the low-glycemic, prebiotic and organoleptic properties described above, as well as optimal cooking properties.

In the method according to the invention, the active substance used is preferably a plant emulsifier, in particular a monoglyceride and/or a diglyceride. It is here advantageous to mix in roughly 0.5% w/w to 5% w/w of the plant emulsifier. This yields an optimal density of starch-lipid complexes through the respective incorporation of a glyceride chain into an amylose helix. The plant emulsifier makes it possible to achieve good product properties (organoleptic and cooking properties).

It is particularly advantageous to supply a plant hydrocolloid as an additional active substance. Combining the hydrothermal treatment of the starch, which is preferably gelatinized to at least 20% in the process, with the plant emulsifier and the hydrocolloid yields a starch matrix that is especially resistant to attack by the digestive enzymes. This makes it possible to achieve a reduced bioavailability (digestion) of the starch in the pasta products manufactured in this way measuring less than 50%. The hydrocolloid here not only forms a barrier directly on the surface of starch grains that did not burst and remain largely intact, or on the surface of starch grain fragments, but also an indirect or “upstream” barrier by helping to make the digestive juices in the small intestine more viscous, slowing the diffusion of the glucose molecules formed by the already slowed enzymatic starch degradation to the wall of the small intestine, and resulting in a lowered glucose resorption rate (low-glycemic effect). Lastly, this results in a majority of the non-degraded starch and a portion of the already degraded starch gets into the large intestine, where it serves as food for the intestinal bacteria, the metabolic products of which have a positive impact on intestinal health (prebiotic effect).

The active substance can also be a swelling flour, in particular a swelling flour with delayed swelling, which preferably involves a flour that contains the active substance galactomannan, obtained from carob seeds, tara seeds, guar seeds or mixtures thereof. The galactomannan can be added in a low to high-viscosity form.

Resistant starch can also be metered in, wherein native starch prepared hydrothermally on-line is preferably added in liquid form as a slurry or suspension.

In the method according to the invention, at least one of the following additives can also be included:
Non-digestible plant fibers;
Soy meal, in particular whole fat soy meal;
A water-soluble protein; in particular lactoprotein or casein.

The time of exposure to vapor in the reactor best ranges from about 10 s to 60 s, preferably from 20 s to 30 s.

The forced conveyance and alternate loading of the raw material mixture in step a) can advantageously take place in a force-conveying two-screw mixer, which preferably is fitted with kneading elements and working elements, wherein forced conveyance is achieved via intermeshing screw elements or conveying elements (mechanical energy input).

The kneading elements are rotationally symmetrical, truncated elements on the screws, wherein the truncated axes are identical to the respective screw axis. These elements narrow the free cross section in the two-screw mixer along the conveying direction. This produces a kneading effect in the force-conveying two-screw mixer, with a stretching of the dough very much resembling that achieved by “kneading with the ball of the thumb”.

The working elements are conveying screws with recesses or openings in the area of the screw web. These openings can be arranged radially outside in the comb area of the screw webs, similarly to a loophole, or they can be arranged radially further in, similarly to a window or porthole in the screw webs. This yields a kneading effect in the force-conveying two-screw mixer with a division and reconstitution of the dough very much resembling “finger kneading”.

The dough in step b) can advantageously be molded in a single-screw extruder. The dough structure is here preferably compacted to a density greater than 1 g/cm³. This helps to solidify and stabilize the starch-protein-active substance-matrix. The matrix consisting of partially gelatinized cereal starch, cereal protein and at least one active substance in the compacted dough hence forms a barrier against enzymatic starch degradation. It envelops the starch grains that have not burst and are largely intact. This matrix acts similarly to a “three-component gluten” or “multi-component gluten”, making it more difficult for enzymes to act on the starch grains or starch fragments embedded therein, and thereby slows their degradation into glucose.

In addition to the mechanical energy input into the raw material mixture or dough described further above to generate the matrix, step a) also involves a hydrothermal treatment with exposure to water, vapor, temperature, pressure and time, wherein:
The metered water preferably has a temperature of 30° C. to 90° C., in particular 75° C. to 85° C.;
The vapor is preferably metered in at an initial vapor temperature of 100° C. to 180° C., in particular 130° C. to 160° C., and at an absolute pressure of 1 bar to 8 bar;
The obtained dough preferably has a water content of 20 to 60% w/w, in particular of 38 to 45% w/w; and
The mass ratio of the metered water quantity to the metered vapor quantity preferably ranges from 5:1 to 1:1, in particular from 4:1 to 2:1, and most preferably measures 3:1.

The mixing ratio between vapor, which has a relatively high temperature, and water, which has a relatively low temperature, makes it possible to efficiently set a target temperature for the process.

These measures are required for the partial gelatinization of the starch necessary to form the matrix.

The raw material dry mixture can consist of gluten protein-free raw materials, e.g., flour and/or semolina based on corn, rice, millet or barley, or of starch. This is important for the manufacture of special pasta products according to the invention for humans allergic to wheat gluten.

In the method according to the invention, all procedural steps are best monitored, regulated and controlled on-line during the process.

The object according to the invention is achieved with respect to the device by means of a system for implementing the method according to the invention described further above. This system according to the invention consists of:
A force-conveying reactor with mixing elements, kneading elements and working elements in an enclosed space;
A raw material metering device for metering a raw material dry mixture into the reactor;
A water metering device for metering in water;
A vapor metering device for metering in vapor;
At least one active substance metering device for metering in an active substance;
A molding device for shaping the dough obtained from the raw material mixture into defined dough structures; and
A pasta-drying device for drying the molded dough structures into pasta products.

The metering devices are preferably arranged in procedural order along the product conveying direction, wherein at least a metering device for raw material, metering device for liquid material or water, a metering device for vapor and a metering device for active substances are respectively arranged in sequence. If needed, another sequence can also be used. In particular, the sequence of metering devices for the water metering device, active substance metering device and vapor metering device can be changed.

The system according to the invention preferably has a recirculating device for returning residual dough obtained in the molding device while shaping or in the drying device while drying.

The force-conveying reactor is preferably a force-conveying two-screw mixer with conveying elements, kneading elements and working elements. The molding device is preferably a single-screw extruder.

The pasta products according to the invention, in which less than 50% of the starch can be digested in the gastrointestinal tract, is manufactured in particular based on the method according to the invention described above. It has 0.5% w/w to 5% w/w of a plant emulsifier, and at least 20% of the starch contained therein is gelatinized.

The emulsifier used in the pasta product is preferably a monoglyceride and/or a diglyceride, and preferably at least 30% of the starch therein is gelatinized. Other than the emulsifier, it can contain at least one of the following additives as well:
A plant hydrocolloid;
A swelling flour, preferably made of swelling flour obtained from carob seeds, tara seeds, or guar seeds;
Non-digestible plant fibers;
Resistant starch;
Soy meal;
Water-soluble protein.

In the pasta products according to the invention, the content of maltose that was obtained through hydrolysis with beta-amylase and determined via iodometric titration ranges from 150 to 450 mg of maltose per gram of starch.

The loss in double refraction in the native starch grains in the pasta products relative to the double refraction of the native starch grains in the raw material as measured via polarization microscopy preferably measures at least 20%.

The raw material dry mixture according to the invention for manufacturing the pasta products according to the invention contains 0.5% w/w to 5% w/w of a plant emulsifier, in particular a monoglyceride and/or a diglyceride.

Other than the emulsifier, it can also exhibit at least one of the following constituents:
A swelling flour, in particular made of swelling flour obtained from carob seeds, tara seeds, or guar seeds;
A plant hydrocolloid;
Non-digestible plant fibers.

Additional advantages, features and possible applications of the invention can be gleaned from the following description of examples based on a drawing, which are not to be construed as limiting. Shown on:

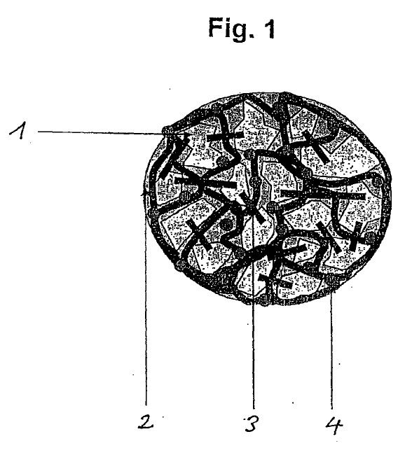

FIG. 1 is a diagrammatic view of the embodiment of starch and active substances into a multi-component matrix for the pasta products according to the invention;

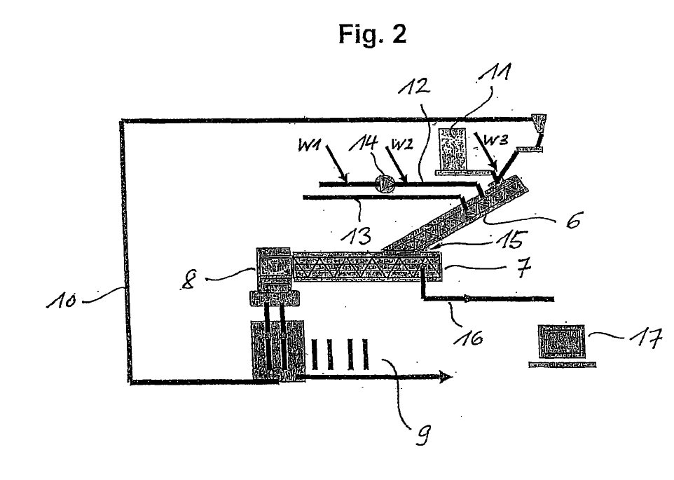

FIG. 2 is a diagrammatic view of an exemplary embodiment of a system according to the invention;

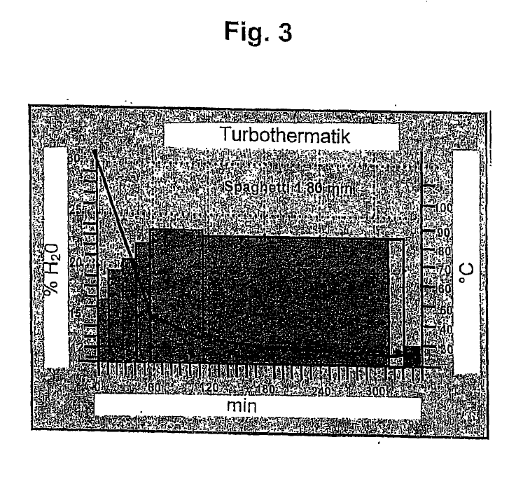

FIG. 3 is a drying diagram showing an example for a drying process for the method according to the invention;

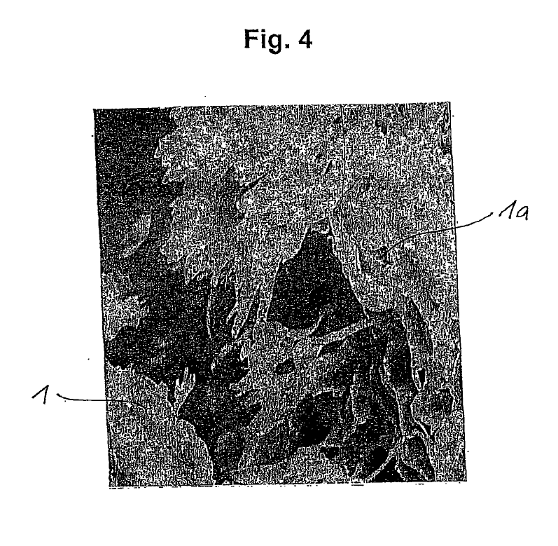

FIG. 4 is a scanning electron microscope photograph which depicts the embodiment of starch into the multi-component matrix, and

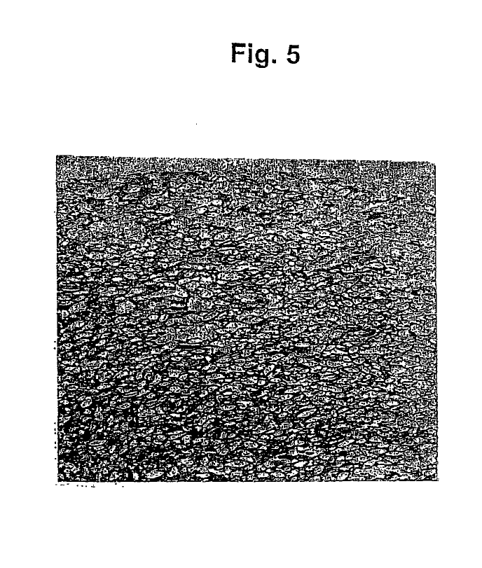

FIG. 5 is a light microscope photograph, which depicts the embodiment of starch in the multi-component matrix.

FIG. 1 shows a diagrammatic view of how the starch particles 1 in the form of semolina or flour along with the active substances 3, 4 are embedded in a multi-component matrix in a preferred embodiment of the pasta products according to the invention. The basic precondition for embedding the carrier and active substances is the homogenous distribution or dispersal of the active substances in the matrix of the water-insoluble gluten proteins 2 or in the structure of the gluten-replacing, swelled or gelatinized starch substances. In this case, bonds are formed between a first active substance (emulsifier) 3 and starch 1, as well as between the first active substance (emulsifier) 3, a second active substance (hydrocolloid) 4, starch 1 and protein 2. This makes it more difficult for enzymes to act on the starch 1 during digestion in the gastrointestinal tract. This results in a reduced bioavailability of the carbohydrates. A type of “multi-component gluten” is obtained, consisting of gelatinized starch, emulsifier and hydrocolloid, as well as a structure consisting of gluten protein, which can also be omitted (gluten-free pasta products). More or less destroyed, swelled or burst starch grains are embedded into this “gluten mass”.

FIG. 2 shows a diagrammatic view of an exemplary embodiment of a system according to the invention. The pasta machine essentially consists of a reactor 6, which is a force-conveying mixer/kneader, in particular in the form of a two-screw extruder, a press 7, which is a pressure-building extruder, in particular in the form of a single-screw extruder, and a pressing head 8 with pasta dies and cutting devices (not shown) for shaping purposes. A pasta dryer 9 is located downstream, and dries the pasta products P molded in the pressing head 8 to yield dry pasta products, which are subsequently packaged (not shown). Pasta breakage or other scrap can be returned to the pasta machine as dry goods via a return line 10. A raw material metering device 11 for metering in a raw material dry mixture, a water metering device 12 for metering water and a vapor metering device 13 for metering in vapor empty into the processing space of the reactor 6. The various active substances, e.g., emulsifier, hydrocolloid and the like can be metered in as solids or liquids via three active substance-metering devices W1, W2 and W3. The metering device W1 upstream from pump 14 is preferably used for metering in active substances in liquid form. Metering device W2 downstream from the pump 14 as well as metering device W3 are suitable both for liquid metering and solid metering of active substances. Upstream from the outlet area 15, into which the force-conveying mixer/kneader reactor 6 empties into the pressure-building press 7, the press has a degassing device 16 through which the product compressed in the press is degassed. A monitor and controller 17 is used to monitor and control the entire pasta process in the reactor 6, the press 7, the pressing head 8 and the dryer 9, as well as metering in the metering devices W1, W2 and W3.

The dry raw materials (e.g., flour, semolina based on wheat or corn) along with the water and vapor are mixed together with the active substances (emulsifier, hydrocolloid) in the force-conveying mixer/kneader 6 and heated, wherein the energy input takes place mechanically or hydrothermally. The mechanical energy input is effected via kneading elements, conveying elements, in particular in the form of conveying screws, working screws and kneading blocks or kneading clusters, while hydrothermal energy input takes place via the interaction between water and vapor. The pasta mass manufactured in this way then enters into the press 7, where it is degassed and compressed, before it is molded in the pressing head 8 by dies and knives (not shown), and dried in the dryer 9, if necessary.

FIG. 3 is a drying diagram showing an example of how drying progresses in the method according to the invention. It depicts the progression over time of the drying temperature and product moisture. The products are dried following the temperature progression shown on the diagram in such a way as to achieve a drying level starting at an initial moisture of 30 to 45% and ending at a final moisture of roughly 12.5% after about 300 min. The high temperatures ranging from 80 to 90° C. have a positive influence on the protein quality. Solidification takes place. The other substances (see description for FIG. 1) are also positively influenced. All told, the matrix (“multi-component gluten”) obtained using the method according to the invention yields good chewing consistency (al dente quality), good cooking properties (little cooking loss) along with slowed starch digestibility. Therefore, the pasta products according to the invention have improved low-glycemic, prebiotic and organoleptic properties.

FIG. 4 is a scanning electron microscope photograph that shows how starch 1 (starch grains or parts of starch grains) are embedded in the multi-component matrix (protein, active substances). FIG. 4 corresponds to the diagrammatic view on FIG. 1. For example, a starch grain 1 is visible on the left bottom corner of the photograph, which is embedded in the protein-active substance matrix. A portion 1a of a starch grain is visible in the top right corner of the photograph, for example.

FIG. 5 is a light microscope photograph that shows how starch is embedded in the multi-component matrix. Embedding the starch/carbohydrate into the protein-active substance matrix protects the carbohydrate in the digestive tract, thereby reducing bioavailability. In this embodiment of the pasta products according to the invention, the bonds between starch, protein and active substances (emulsifier and hydrocolloid) work particularly well, since the density of the pressed products is greater than 1 g/cm³.

Instead of the continuous process described here with the use of a two-screw extruder for mixing purposes, use can also be made of a discontinuous process with mixing trough. The process as described above then ensues starting at the press 7.

1. A method for manufacturing pasta products, less than 50% of the starch in which is digestible in the gastrointestinal tract, wherein the method involves the following steps:
a) Supplying a raw material dry mixture containing flour and/or semolina and protein along with water, vapor and at least one active substance to a closed, force-conveying reactor, in which mixing produces a moistened raw material mixture, which is alternately subjected to kneading and working while exposed to a temperature and pressure during a predetermined retention time in the reactor, in order to partially convert the starch into a solubilized or swellable state, thereby working together with the protein and active substance to form a matrix permeating the dough obtained in this way;
b) Molding the dough obtained in this way into defined dough structures; and
c) Drying the molded dough structures into pasta products.

2. The method according to claim 1, characterized in that the supplied active substance is a plant emulsifier.

3. The method according to claim 2, characterized in that a monoglyceride and/or diglyceride is metered in as the plant emulsifier.

4. The method according to one of the preceding claims, characterized in that a plant hydrocolloid is supplied as the additional active substance.

5. The method according to one of the preceding claims, characterized in that a swelling flour, in particular a swelling flour with delayed swelling, is supplied as the additional active substance.

6. The method according to claim 4 or 5, characterized in that the swelling flour is flour obtained from carob seeds, tara seeds, or guar seeds (active substance from these raw materials=galactomannan).

7. The method according to one of the preceding claims, characterized in that low to high-viscous galactomannan is used as the additional active substance (=active substance from these seeds).

8. The method according to one of the preceding claims, characterized in that resistant starch is metered in as the additional active substance.

9. The method according to claim 8, characterized in that native starch is supplied preferably prepared on-line in liquid form as a slurry or suspension.

10. The method according to one of the preceding claims, characterized in that non-digestible plant fibers are mixed in.

11. The method according to one of the preceding claims, characterized in that a soy meal is metered in.

12. The method according to claim 11, characterized in that a whole fat soy mean is metered in as the soy meal.

13. The method according to one of the preceding claims, characterized in that a water-soluble protein is added.

14. The method according to claim 9, characterized in that a lactoprotein or casein is metered in as the water-soluble protein.

15. The method according to one of the preceding claims, characterized in that the time of exposure to the vapor in the reactor measures about 10 s to 60 s, preferably 20 s to 30 s.

16. The method according to one of the preceding claims, characterized in that the forced conveyance and alternate loading of the raw material mixture in step a) take place in a force-conveying two-screw mixer.

17. The method according to one of the preceding claims, characterized in that the dough is molded in step b) in a single-screw extruder.

18. The method according to one of the preceding claims, characterized in that the metered water has a temperature of 30° C. to 90°, in particular 75° C. to 85° C.

19. The method according to one of the preceding claims, characterized in that vapor is metered in at an initial vapor temperature of 100° C. to 180° C., in particular 130° C. to 160° C.

20. The method according to one of the preceding claims, characterized in that the obtained dough has a water content of 20 to 60% w/w, in particular 38 to 45% w/w.

21. The method according to one of the preceding claims, characterized in that the mass ratio of the metered water quantity to the metered vapor quantity preferably ranges from 5:1 to 1:1, in particular from 4:1 to 2:1, and most preferably measures 3:1.

22. The method according to one of the preceding claims, characterized in that the raw material dry mixture consists of gluten-free raw materials, e.g., flour and/or semolina based on corn, rise, millet or barley, or of starch.

23. The method according to one of the preceding claims, characterized in that all procedural steps are monitored, regulated and controlled on-line during the process.

24. A system for manufacturing pasta products, less than 50% of the starch in which is digestible in the gastrointestinal tract, in particular for implementing a method according to one of claims 1 to 23, wherein the system has:
A force-conveying reactor (6) with mixing elements, kneading elements and working elements in an enclosed space;
A raw material metering device (11) for metering in a raw material dry mixture;
A water metering device (12) for metering in water;
A vapor metering device (13) for metering in vapor;
At least one active substance metering device (W1, W2, W3) for metering in an active substance;
A molding device (8) for shaping the dough obtained from the raw material mixture into defined dough structures; and
A pasta-drying device (9) for drying the molded dough structures into pasta products.

25. The system according to claim 24, characterized in that it has a device for packaging the dough structure coming from the molding device instead of a pasta drying device.

26. The system according to claim 24 or 25, characterized in that it has a recirculating device (10) for returning residual dough obtained in the molding device while shaping or in the drying device while drying.

27. The system according to one of claims 24 to 26, characterized in that the force-conveying reactor is a force-conveying two-screw mixer (6).

28. The system according to one of the claims, characterized in that the molding device is a single-screw extruder (7).

29. A pasta product, less than 50% of the starch in which is digestible in the gastrointestinal tract, in particular manufactured based on a method according to one of claims 1 to 23, characterized in that it exhibits at least one active substance in a matrix containing the starch, and at least 20% of the starch contained therein is gelatinized.

30. The pasta product according to claim 29, characterized in that the active substance is a plant emulsifier.

31. The pasta product according to claim 30, characterized in that the pasta product has 0.5% w/w to 5% w/w of a plant emulsifier.

32. The pasta product according to claim 30 or 31, characterized in that it contains monoglyceride and/or diglyceride as the emulsifier.

33. The pasta product according to one of claims 29 to 32, characterized in that at least 30% of the starch contained therein is gelatinized.

34. The pasta product according to one of claims 29 to 33, characterized in that it has a plant hydrocolloid in addition to the emulsifier.

35. The pasta product according to one of claims 29 to 34, characterized in that it has swelling flour in addition to the emulsifier.

36. The pasta product according to claim 35, characterized in that the swelling flour is flour obtained from carob seeds, tara seeds, or guar seeds

37. The pasta product according to one of claims 29 to 36, characterized in that it contains non-digestible plant fibers.

38. The pasta product according to one of claims 29 to 37, characterized in that, other than the emulsifier, it also has at least one of the following constituents: resistant starch, soy meal, water-soluble protein.

39. The pasta product according to one of claims 29 to 38, characterized in that it contains no gluten protein.

40. The pasta product according to one of claims 29 to 39, characterized in that its content maltose that was obtained through hydrolysis with beta-amylase and determined via iodometric titration ranges from 150 to 450 mg of maltose per gram of starch.

41. The pasta product according to one of claims 29 to 40, characterized in that the loss in double refraction in the native starch grains in the pasta products relative to the double refraction of the native starch grains in the raw material as measured via polarization microscopy preferably measures at least 20%.

42. A raw material dry mixture for manufacturing a pasta product according to one of claims 29 to 41, characterized in that the at least one active substance is contained in the dry mixture.

43. The raw material dry mixture according to claim 42, characterized in that the at least one active substance is a plant emulsifier, in particular a monoglyceride and/or diglyceride.

44. The raw material dry mixture according to claim 43, characterized in that it contains 0.5% w/w to 5% w/w of the plant emulsifier.

45. The raw material dry mixture according to claim 43 or 44, characterized in that, other than the emulsifier, it also contains a swelling flour, in particular a swelling flour obtained from carob seeds, tara seeds, or guar seeds.

46. The raw material dry mixture according to one of claims 43 to 45, characterized in that, other than the emulsifier, it also contains a plant hydrocolloid.

47. The raw material dry mixture according to one of claims 42 to 46, characterized in that it contains non-digestible plant fibers.
